(19) United States
(12) Patent Application Publication
(10) Pub. No.: US 2013/0151303 A1
(43) Pub. Date: Jun. 13, 2013

(54) CARBON FOOTPRINT RESTRICTION IN SEQUENCING PROCESS

(71) Applicant: Stefan Kienzle, St. Leon-Rot (DE)

(72) Inventor: Stefan Kienzle, St. Leon-Rot (DE)

(73) Assignee: SAP AG, Walldorf (DE)

(21) Appl. No.: 13/324,628

(22) Filed: Dec. 13, 2011

(51) Int. Cl. G06Q 10/06

(52) U.S. Cl. 705/7.22; 705/7.27; 705/7.12

(57) ABSTRACT

An example system defines a carbon footprint restriction type in a manufacturing process. The system may comprise a carbon equivalent computation module and a carbon footprint computation module. The carbon equivalent computation module may define a carbon equivalent base attribute for each component unit of the manufacturing process and a carbon equivalent production attribute for the manufacturing process. The carbon footprint computation module may compute a carbon footprint value of an assembled product produced from the manufacturing process of the component units based on the carbon equivalent base attribute of each component unit and the carbon equivalent production attribute of the manufacturing process. An indicator associated with the carbon footprint value of the assembled product is displayed.

### FIELD

The present disclosure relates generally to data analysis, and in a specific example embodiment, to define carbon footprint restrictions in a manufacturing process.

### BACKGROUND

Conventionally, a manufacturing planning process does not take into account the carbon footprint of manufacturing a product. Also, the carbon footprint value may not be consistent throughout the flow of logistic processes because different combinations of materials and different processes produce different carbon footprint emissions. Further, common manufacturing processes do not have the means to track in real time how much carbon is generated during a manufacturing process. As such, common manufacturing planning processes cannot optimize their manufacturing processes in terms of carbon emission restrictions and other restrictions because this information is missing from their logistic planning process.

### BRIEF DESCRIPTION OF DRAWINGS

The appended drawings merely illustrate example embodiments of the present invention and cannot be considered as limiting its scope.

FIG. 1 is a block diagram illustrating an example of a system in which embodiments may be practiced.

FIG. 2 is a block diagram illustrating a restriction module, in accordance with an example embodiment.

FIG. 3 is a block diagram illustrating a chart of carbon footprint from process orders within a time interval.

FIG. 4 is a block diagram illustrating an example of a manufacturing process, in accordance with an example embodiment, incorporating a carbon footprint component.

FIG. 5 is a block diagram illustrating another example of a manufacturing process, in accordance with an example embodiment, incorporating a carbon footprint component.

FIG. 6 is a flowchart of a method, in accordance with an example embodiment, for evaluating a manufacturing process with carbon footprint restrictions.

FIG. 7 is a flowchart of a method, in accordance with an example embodiment, for incorporating carbon footprint restrictions in a manufacturing process.

FIG. 8 is a block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments. It will be evident, however, to those skilled in the art that embodiments of the inventive subject matter may be practiced without these specific details. In general, well-known instruction instances, protocols, structures, and techniques have not been shown in detail.

Example systems and methods to define a carbon footprint restriction type in a manufacturing process are described. In one example embodiment, a carbon equivalent computation module defines a carbon equivalent base attribute for each component unit of the manufacturing process and a carbon equivalent production attribute for the manufacturing process. A carbon footprint computation module computes a carbon footprint value of an assembled product produced from the manufacturing process of the component units based on the carbon equivalent base attribute of each component unit and the carbon equivalent production attribute of the manufacturing process. An indicator associated with the carbon footprint value of the assembled product is displayed.

In one example embodiment, an average carbon footprint computation module determines an average carbon footprint value based on the carbon footprint values of manufacturing processes over a limited period of time (also referred to as an interval). A carbon restriction factor computation module may define a carbon restriction factor based on the average carbon footprint of the manufacturing process. A manufacturing production schedule module may generate a manufacturing production schedule based on the carbon restriction factor and a manufacturing restriction factor. The manufacturing production schedule can be adjusted to limit the carbon footprint value below the average carbon footprint value.

In one example embodiment, the assembly product comprises respective quantities of each component unit. The carbon footprint value may comprise the sum of the carbon equivalent base attribute for each component unit of the manufacturing process multiplied by the respective quantity for each component unit, and the carbon equivalent production attribute for assembling the component units into the assembled product.

In another example embodiment, the carbon equivalent computation module associates the carbon footprint value of a component unit with one of characteristic values. The characteristic values may comprise a very low value, a low value, a medium value, a high value, and a very high value (or any other set of values). An evaluation module may evaluate a manufacturing production schedule based on a carbon footprint violation factor and penalty factors. The carbon footprint computation module may compute an actual carbon footprint for the manufacturing process. The actual carbon footprint comprises the sum of characteristic values of each component unit. The carbon footprint computation module may compute an average carbon footprint for the manufacturing processes over a time interval and compute the carbon footprint violation factor based on the actual carbon footprint of the manufacturing process exceeding the average carbon footprint of the manufacturing process.

The carbon equivalent base attribute for each component unit of the manufacturing process may be an intrinsic value corresponding to the production and transportation of the component unit.

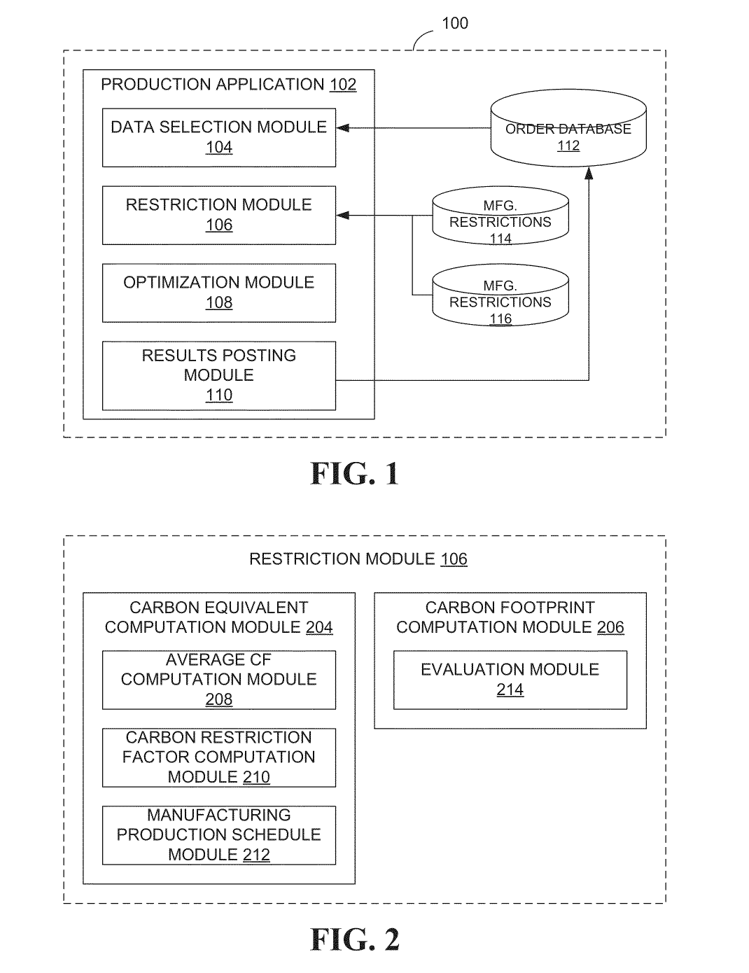

With reference to FIG. 1, a system 100 in which example embodiments may be practiced is shown. The system 100 comprises a production application 102 that is communicatively couples an order database 112, a manufacturing restriction database 114, and a carbon footprint restriction database 116. The production application 102 may reside in a computer such as a server. Other computer systems may also be communicatively coupled via a network to the production application 102 or the system 100. The network may comprise, for example, one or more of a wired or wireless network, a local area network (LAN), or a wide area network (WAN). While the example embodiment of FIG. 1 shows production application 102 in one server system, alternative embodiments may contemplate the various components of the production application 102 and databases 112, 114, and 116 being embodied within several systems (e.g., cloud computing system, server farm system).

In one embodiment, the production application 102 includes a data selection module 104, a restriction module 106, an optimization computation module 108, and a result posting module 110. The production application 102 illustrates an example of a flow of the manufacturing scenario where the production schedule is to be optimized based on restrictions.

The data selection module 104 retrieves data for an order from the order database 112. For example, the order may include an identification of materials to be used in a production of an end product. The order may also include the amount of material of each component unit needed to build the end product.

The restriction module 106 retrieves manufacturing restrictions from manufacturing restriction database 114 and carbon footprint restriction from carbon footprint restriction database 116. The manufacturing restrictions include for example customer due dates, production bottlenecks, capacity utilization, supply chain parameters. In one embodiment, the carbon footprint restriction includes carbon restrictions associated with the assembly of the component units related to the order received at data selection module 104. The carbon restrictions may be defined with a carbon footprint attribute associated with each component unit or material unit. Every movement or manipulation of the good will add carbon to the carbon receipt or to the component, sub-assembly, or the finished product.

The carbon footprint embedded within the component is stored in carbon footprint restriction database 116. Some components are assembled together in a sub-assembly. This sub-assembly inherit the carbon footprint of the single build in components and so on. The carbon information is stored cumulated within a material master stock inventory or a warehouse management storage area. As such, the restriction module 106 is capable of tracking the carbon footprint of a manufacturing process in real time. The restriction module 106 is discussed in further detail in connection with FIG. 2 below.

The optimization computation module 108 enables computation to optimize the production schedule of a manufacturing process based on manufacturing restrictions and carbon restrictions. The optimization computation module 108 may use optimization algorithms. For example, a manufacturing process may involve assembling multiple components at different times based on multiple orders. As such, grouping of orders with similar attributes of colors, options, components together reduces the carbon footprint because the in-house logistics (supply to line) could be done together. Orders with fewer options and less workload result in less carbon emission from the product assembly. Thus, each sequence may result in different carbon footprints.

To minimize the carbon footprint of a product, it is desirable to minimize the carbon footprint in each business or manufacturing process. The production or assembly sequence may have a high impact on the overall carbon footprint because the process controls multiple sub processes e.g. in logistic.

An example of a production process includes several stages: good received, transportation to store, stock in warehouse, release from stock, supply to line, production, goods issued. As a component is moved through the manufacturing t

The result posting module 110 registers the carbon footprint associated with each order or each manufacturing process and updates the order database 112 with the corresponding carbon footprint attribute.

FIG. 2 is a block diagram illustrating the restriction module 106. The restriction module 106 may include a carbon equivalent computation module 204 and a carbon footprint computation module 206.

The carbon equivalent computation module 204 qualifies and/or quantifies the carbon footprint associated with each component unit of a manufacturing process or a manufacturing order. The carbon footprint of each component unit and a corresponding assembly sequence are taken into account doing a production planning such as a sequencing process.

In one embodiment, the carbon quantity is defined using a fuzzy membership function on option level (characteristic value combination CV). The fuzzy membership function may be defined, for example, as with very low, low, medium, high and very high carbon footprint with assignment to a component unit, such as a vehicle option (characteristic value combination CV).

Examples for carbon Footprint of different vehicle options are:

Gearbox=‘Automatic’->High,

Gearbox=‘Manual’->medium,

Light=‘Standard’->low

Light=‘Xenon’->very high

For example, the actual carbon footprint for one order based on the previously described fuzzy membership may be defined with the following algorithm:

Actualᵢ=ΣCVₖ

where CV represents Characteristic Values, i represents the order within an interval, and k represents a characteristic value.

For example, order “4711” may include the following actual carbon footprint:

### Gearbox=‘Automatic’->High

### Light=‘Xenon’->Very High

In another example embodiment, the carbon equivalent computation module 204 defines a carbon equivalent base attribute for each component unit of a manufacturing process and a carbon equivalent production attribute of the manufacturing process. For example, a component unit may have a corresponding carbon equivalent base value. The assembly of the component units may also have a corresponding carbon equivalent production value.

The carbon footprint computation module 206 computes a carbon footprint value of an assembled product produced from the manufacturing process of the component units based on the carbon equivalent base attribute of each component unit and the carbon equivalent production attribute of the manufacturing process. For example, an assembled product may have a corresponding carbon equivalent assembled product value based on the carbon equivalent base attribute of each component unit and the carbon equivalent production attribute of the manufacturing process.

In one example embodiment, the carbon equivalent computation module 204 includes an average carbon footprint computation module 208, a carbon restriction factor computation module 210, and a manufacturing production schedule module 212.

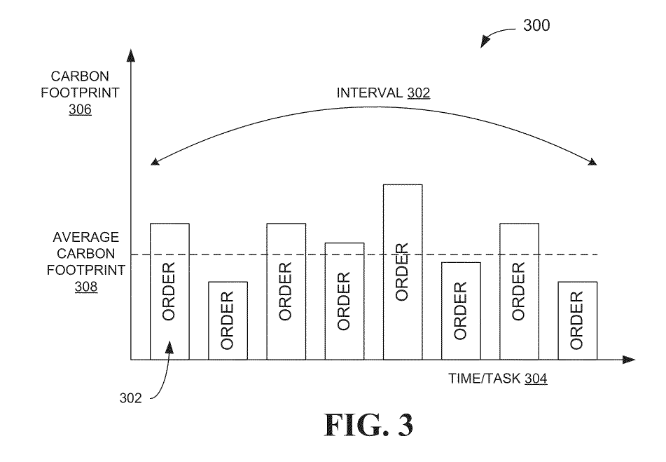

The average carbon footprint computation module 208 determines an average carbon footprint value based on the carbon footprint values of manufacturing processes over a limited period of time. For example, a manufacturing process based on a same order may generate different levels of carbon footprint over a period of time due to a multitude of manufacturing factors. The different levels of carbon footprints over a time interval 302 are illustrated in a chart 300 in FIG. 3. The horizontal axis 304 represents orders 302 or tasks placed in the time interval 302. The vertical axis 306 represents the amount of carbon footprint associated with each order. The average carbon footprint 308 per order within the interval 203 is represented by the horizontal line across the chart 300.

For example, the average carbon footprint (Avg) for an interval i based on the previously described fuzzy membership may be defined with the following algorithm:

Avgᵢ=ΣActual i/i

where CV represents Characteristic Values, i represents the order within an interval.

In one embodiment, the new restriction carbon type defines an average maximum carbon quantity (Kilograms or Pounds) per produced unit (order) in the area of assembly/production. The average is determined for a defined time interval (e.g., number of orders, Shift, Day or week).

Returning to FIG. 2, the carbon restriction factor computation module 210 defines a carbon restriction factor based on the average carbon footprint of the manufacturing process. For example, the average carbon footprint of an order may be used as a restriction in a manufacturing process to limit the overall amount of carbon emission. A violation may occur when the actual carbon footprint for one order exceeds the average carbon footprint.

For example, the carbon footprint violation (CFi) based on the previously described fuzzy membership may be defined with the following algorithm:

CFi=Prioᵢ*(Actualᵢ−Avgᵢ)²/Avgᵢ²

where Prio represents the priority value for manufacturing and carbon restrictions.

The manufacturing production schedule module 212 may generate a manufacturing production schedule based on the carbon restriction factor and a manufacturing restriction factor. The manufacturing production schedule may be adjusted to limit the carbon footprint value to be below the average carbon footprint value.

In one embodiment, the manufacturing production schedule module 212 includes an evaluation module 214 to evaluate a manufacturing production schedule based on a carbon footprint violation factor and penalty factors.

The carbon footprint computation module 206 computes an actual carbon footprint for the manufacturing process. The actual carbon footprint comprises the sum of characteristic values of each component unit. The carbon footprint computation module 206 compute an average carbon footprint for the manufacturing processes over a time interval then computes the carbon footprint violation factor based on the actual carbon footprint of the manufacturing process exceeding the average carbon footprint of the manufacturing process.

For example, the evaluation module 214 may include an evaluation function algorithm such as:

$$Prio 1 * block penalty + Prio 2 * distance penalty + Prio 3 * earliness penalty + Prio 4 * delay penalty + … + Prio 5 * carbon penalty ( CFi ) = evaluation function ( Fitness )$$

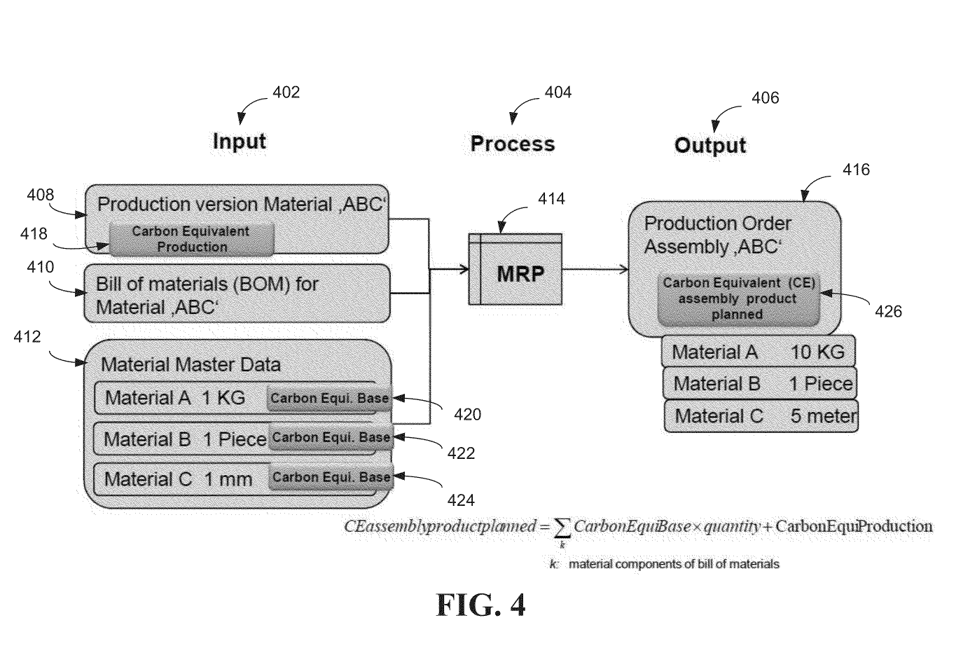

FIG. 4 is a block diagram illustrating an example of a manufacturing process 404 that incorporates a carbon footprint component. A material master database contains a new attribute of carbon equivalent base related to the basic unit of measure such as a piece, kilogram, meter, etc. This value may be delivered by a service provider. Within the material master segment for inventory management on a quantity basis, the new attribute carbon equivalent on stock keeps the carbon footprint information. In case of subassemblies or final assemblies, the new carbon footprint information is a total result of the footprint of the single input materials (bill of material) plus an expert value (intersection value calculate from history) for the production activity. This further new attribute carbon equivalent for production is part of the production version master data. The computation is performed within the material resource planning process (MRP 414). As a result of the MRP 414, a production order is generated with a new attribute new attribute carbon equivalent assembly product planned.

The production confirmation process then posts good issue for the build in components and goods receipts for the assembly product. At this point in time, the carbon equivalent of the components will be reduced because the stock level will be reduced and the carbon equivalent of the assembly product in stock will be taken from production order attribute carbon equivalent assembly product planned.

To illustrate the above process, the manufacturing process 404 receives processes elements from an input 402 to an output 406. The input 402 includes, for example, a production version material ABC 408, a bill of materials for material ABC 410, a material master data 412. The production version material ABC 408 is associated with a carbon equivalent production attribute 418. The material master data 412 includes, for example, 1 kg of material A, one piece of material B, 1 mm of material C. Each of the component material is associated with a corresponding carbon equivalent base attribute 420, 422, and 424. The manufacturing process 404 includes, for example, a material resource planning process. The output 406 includes a production order assembly 416. The production order assembly 416 is associated with a carbon equivalent assembly product planned attribute 426. Thus, the carbon equivalent assembly product planned attribute is equal to the sum of carbon equivalent base attributes 420, 422, 424 times their respective quantities (1 kg, 1 piece, 1 mm, and so forth) in addition to the carbon equivalent production attribute 418.

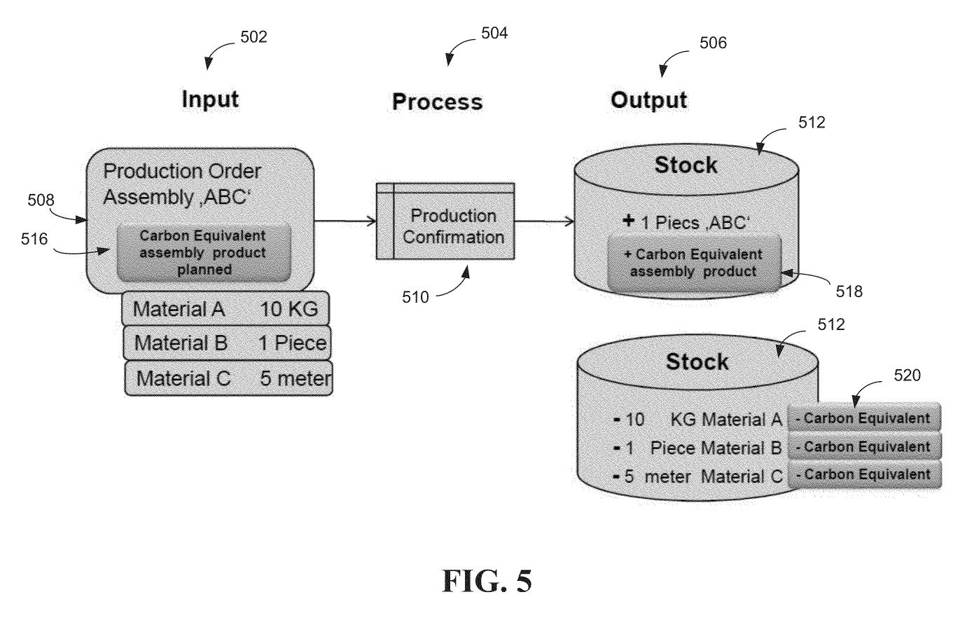

FIG. 5 is a block diagram illustrating another example of a manufacturing process 504 that incorporates a carbon footprint component. The manufacturing process 504 receives processes elements from an input 502 to an output database 506. The input 502 includes, for example, a production order assembly ABC 508. The production order assembly ABC 508 is associated with a carbon equivalent assembly product plan attribute 516. The manufacturing process 504 includes, for example, a product confirmation process 510. The output database 506 includes a stock comprising one piece of assembled product ABC 512. The assembled product ABC 512 is associated with a carbon equivalent assembly product attribute 518. The production order assembly 416 of FIG. 4 is associated with a carbon equivalent assembly product planned attribute 426 of FIG. 4. A stock database 514 stores the carbon equivalent attributes 520 of the corresponding materials.

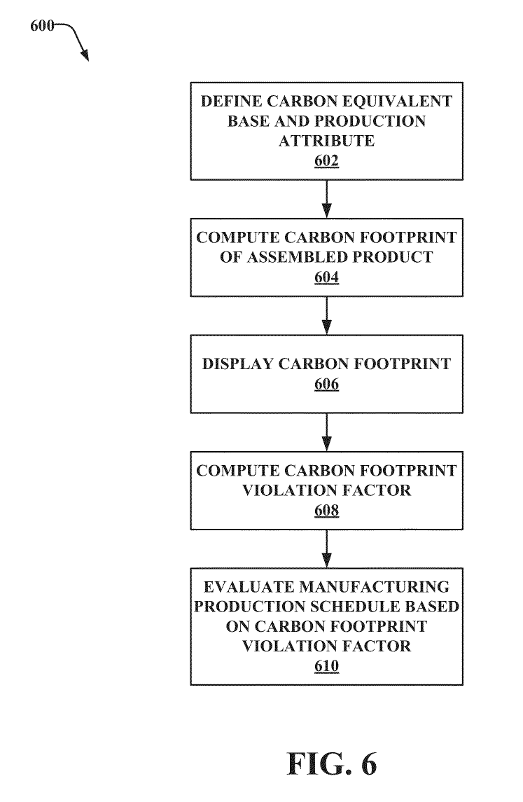

FIG. 6 is a flowchart of an example method 600 for evaluating a manufacturing process with carbon footprint restrictions. At 602, a carbon equivalent base attribute is defined for each component unit of a manufacturing process and a carbon equivalent production attribute of the manufacturing process. In one embodiment, the carbon equivalent computation module 204 of FIG. 2 performs the operation of defining the carbon equivalent base attribute for each component unit of the manufacturing process and the carbon equivalent production attribute of the manufacturing process.

At 604, a carbon footprint value of an assembled product produced from the manufacturing process of the component units is computed based on the carbon equivalent base attribute of each component unit and the carbon equivalent production attribute of the manufacturing process. In one example embodiment, the carbon footprint computation module 206 of FIG. 2 performs the computation.

At 606, an indicator associated with the carbon footprint value of the assembled product may be displayed to a user. For example, the actual carbon footprint value in term of volume, or an indicator such as a scale (e.g., from a minimum to a maximum) may be displayed. In another embodiment, a visual indicator may be used to communicate the carbon footprint value. For example, a color scheme (e.g., green to red) may be used. The indicator may be displayed or communicated to the user through various means such as a display monitor, a dial, colored buttons, and so forth.

At 608, a carbon footprint violation factor is computed based on an actual carbon footprint of the manufacturing process exceeding an average carbon footprint of the manufacturing process. In one embodiment, the evaluation module 214 computes a carbon footprint violation factor based on the actual carbon footprint of the manufacturing process exceeding the average carbon footprint of the manufacturing process. In another embodiment, the carbon footprint violation factor may also be displayed.

At 610, a manufacturing production schedule is evaluated based on the carbon footprint violation factor and penalty factors. In one embodiment, the evaluation module 214 evaluates the manufacturing production schedule based on the carbon footprint violation factor and penalty factors.

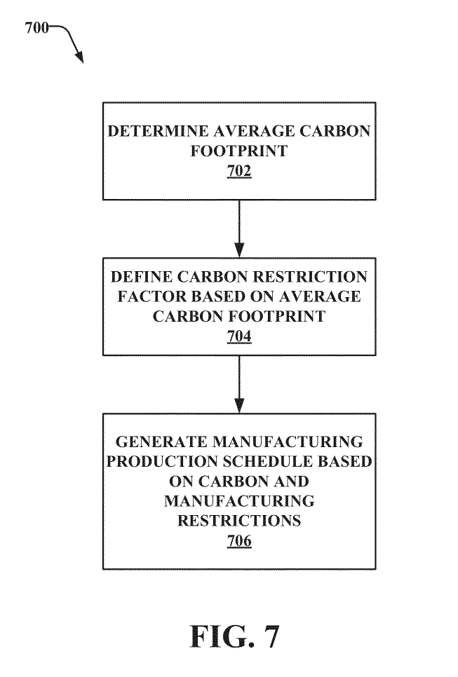

FIG. 7 is a flowchart of example method 700 for incorporating carbon footprint in a manufacturing process. At 702, an average carbon footprint value is determined based on the carbon footprint values of manufacturing processes over a limited period of time or an interval. In one embodiment, the average carbon footprint computation module 208 of FIG. 2 performs the computation. In another embodiment, the average carbon footprint computation module 208 of FIG. 2 also computes an actual carbon footprint for the manufacturing process. The actual carbon footprint includes the sum of characteristic values of each component unit.

At 704, a carbon restriction factor is defined based on the average carbon footprint of the manufacturing process. In one embodiment, the carbon restriction factor computation module 210 of FIG. 2 defines the carbon restriction factor for the manufacturing process.

At 706, a manufacturing production schedule is generated based on the carbon restriction factor and a manufacturing restriction factor. In one embodiment, the manufacturing production schedule module 212 of FIG. 2 generates a manufacturing production schedule based on the carbon restriction factor and the manufacturing restriction factor. The manufacturing production schedule is adjusted to limit the carbon footprint value below the average carbon footprint value.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

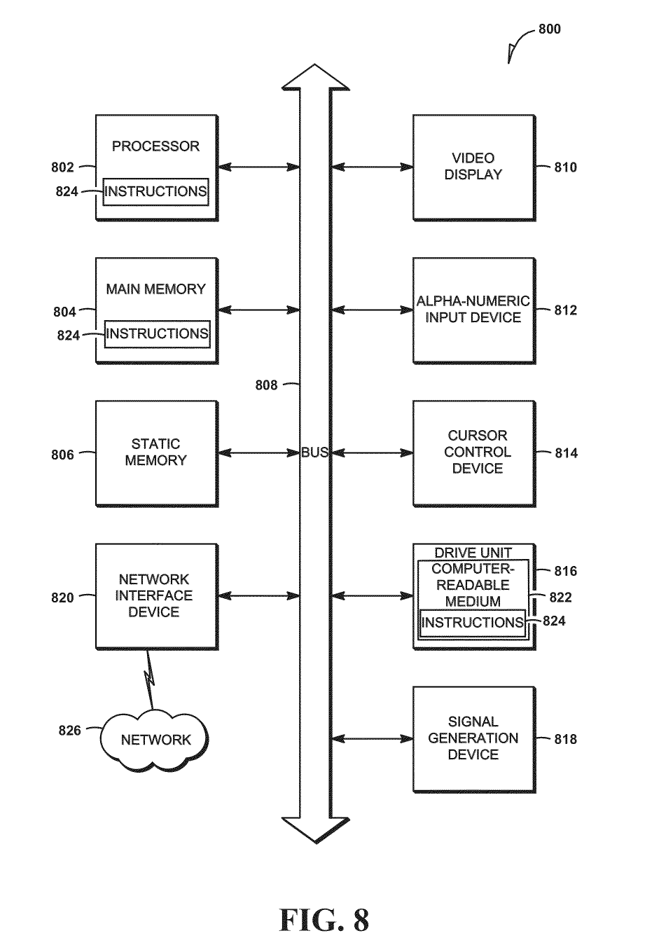

With reference to FIG. 8, an example embodiment extends to a machine in the example form of a computer system 800 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, a server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 may include a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). In example embodiments, the computer system 800 also includes one or more of an alpha-numeric input device 812 (e.g., a keyboard), a user interface (UI) navigation device or cursor control device 814 (e.g., a mouse), a disk drive unit 816, a signal generation device 818 (e.g., a speaker), and a network interface device 820.

The disk drive unit 816 includes a machine-readable storage medium 822 on which is stored one or more sets of instructions 824 and data structures (e.g., software instructions) embodying or used by any one or more of the methodologies or functions described herein. The instructions 824 may also reside, completely or at least partially, within the main memory 804 or within the processor 802 during execution thereof by the computer system 800, the main memory 804 and the processor 802 also constituting machine-readable media.

While the machine-readable storage medium 822 is shown in an exemplary embodiment to be a single medium, the term “machine-readable storage medium” may include a single storage medium or multiple media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that causes the machine to perform any one or more of the methodologies of embodiments of the present description, or that is capable of storing, encoding, or carrying data structures used by or associated with such instructions. The term “machine-readable storage medium” shall accordingly be taken to include, but not be limited to, solid-state memories, optical and magnetic media, and non-transitory machine-readable storage media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 824 may further be transmitted or received over a communications network 826 using a transmission medium via the network interface device 820 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

It should be noted that various modifications and changes may be made to these example embodiments without departing from the broader spirit and scope of the present invention.

As used herein, the term “or” may be construed in either an inclusive or exclusive sense. Additionally, although various example embodiments discussed focus on a specific network-based environment, the embodiments are given merely for clarity in disclosure. Thus, any type of electronic system, including various system architectures, may employ various embodiments of the search system described herein and is considered as being within a scope of example embodiments.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of the example embodiments as represented by the appended claims. The specification and drawings are, accordingly, to be regarded in an illustrative rather than a restrictive sense.

What is claimed is:

1. A computerized method comprising:
defining a carbon equivalent base attribute for each component unit of a manufacturing process and a carbon equivalent production attribute of the manufacturing process;
computing, using at least one processor, a carbon footprint value of an assembled product produced from the manufacturing process of the component units based on the carbon equivalent base attribute of each component unit and the carbon equivalent production attribute of the manufacturing process; and
displaying an indicator associated with the carbon footprint value of the assembled product.

2. The computerized method of claim 1, further comprising:
determining an average carbon footprint value based on the carbon footprint value of a plurality of manufacturing processes over a limited period of time.

3. The computerized method of claim 2, further comprising:
defining a carbon restriction factor based on the average carbon footprint value of the manufacturing process; and
generating a manufacturing production schedule based on the carbon restriction factor and a manufacturing restriction factor.

4. The computerized method of claim 3, further comprising:
adjusting the manufacturing production schedule to limit the carbon footprint value below the average carbon footprint value.

5. The computerized method of claim 1, wherein the assembled product comprises respective quantities of each component unit.

6. The computerized method of claim 5, wherein the carbon footprint value comprises the sum of the carbon equivalent base attribute for each component unit of the manufacturing process multiplied by the respective quantities for each component unit, and the carbon equivalent production attribute for assembling the component unit into the assembled product.

7. The computerized method of claim 1, further comprising:
associating the carbon footprint value of the component unit with one of a plurality of characteristic values.

8. The computerized method of claim 7, wherein the plurality of characteristic values comprises a very low value, a low value, a medium value, a high value, and a very high value.

9. The computerized method of claim 7, further comprising:
computing an actual carbon footprint for the manufacturing process, the actual carbon footprint comprising a sum of characteristic values of each component unit.

10. The computerized method of claim 9, further comprising:
computing an average carbon footprint for the plurality of manufacturing processes over a time interval.

11. The computerized method of claim 10, further comprising:
computing a carbon footprint violation factor based on the actual carbon footprint of the manufacturing process exceeding the average carbon footprint of the manufacturing process.

12. The computerized method of claim 11, further comprising:
evaluating a manufacturing production schedule based on the carbon footprint violation factor and penalty factors.

13. The computerized method of claim 1, wherein the carbon equivalent base attribute for each component unit of the manufacturing process is intrinsic to the production and transportation of the component unit.

14. A system comprising:
a processor comprising a carbon equivalent computation module and a carbon footprint computation module,
the carbon equivalent computation module to define a carbon equivalent base attribute for each component unit of a manufacturing process and a carbon equivalent production attribute of the manufacturing process; and
the carbon footprint computation module to compute a carbon footprint value of an assembled product produced from the manufacturing process of the component unit based on the carbon equivalent base attribute of each component unit and the carbon equivalent production attribute of the manufacturing process.

15. The system of claim 14, further comprising:
an average carbon footprint computation module to determine an average carbon footprint value based on the carbon footprint value of a plurality of manufacturing processes over a limited period of time;
a carbon restriction factor computation module to define a carbon restriction factor based on the average carbon footprint value of the manufacturing process; and
a manufacturing production schedule module to generate a manufacturing production schedule based on the carbon restriction factor and a manufacturing restriction factor, the manufacturing production schedule adjusted to limit the carbon footprint value below the average carbon footprint value.

16. The system of claim 14, wherein the assembled product comprises respective quantities of each component unit, wherein the carbon footprint value comprises a sum of the carbon equivalent base attribute for each component unit of the manufacturing process multiplied by the respective quantities for each component unit, and the carbon equivalent production attribute for assembling each component unit into the assembled product.

17. The system of claim 14, wherein the carbon equivalent computation module is to associate the carbon footprint value of a component unit with one of a plurality of characteristic values, the plurality of characteristic values comprising a very low value, a low value, a medium value, a high value, and a very high value.

18. The system of claim 17, further comprising:
an evaluation module to evaluate a manufacturing production schedule based on a carbon footprint violation factor and penalty factors,
wherein the carbon footprint computation module is to compute an actual carbon footprint for the manufacturing process, the actual carbon footprint comprising a sum of characteristic values of each component unit, to compute an average carbon footprint for a plurality of manufacturing processes over a time interval, to compute the carbon footprint violation factor based on the actual carbon footprint of the manufacturing process exceeding the average carbon footprint of the manufacturing process.

19. The system of claim 14, wherein the carbon equivalent base attribute for each component unit of the manufacturing process is intrinsic to the production and transportation of the component unit.

20. A non-transitory machine-readable storage medium storing instructions which, when executed by at least one processor, performs operations comprising:
defining a carbon equivalent base attribute for each component unit of a manufacturing process and a carbon equivalent production attribute of the manufacturing process;
computing a carbon footprint value of an assembled product produced from the manufacturing process of the component unit based on the carbon equivalent base attribute of each component unit and the carbon equivalent production attribute of the manufacturing process; and
displaying an indicator associated with the carbon footprint value of the assembled product.
